(19) United States
(12) Patent Application Publication
(10) Pub. No.: US 2016/0032593 A1
(43) Pub. Date: Feb. 4, 2016

(54) COVER PANEL

(71) Applicant: Eran BITERMAN, Kiryat Ata (IL)

(72) Inventor: Eran BITERMAN, Kiryat Ata (IL)

(21) Appl. No.: 14/813,970

(22) Filed: Jul. 30, 2015

Related U.S. Application Data
(60) Provisional application No. 62/031,396, filed on Jul. 31, 2014.

(51) Int. Cl. E04F 13/08; B29C 51/10; E04F 13/16; E04F 13/072; E04F 13/09

(52) U.S. Cl. CPC E04F 13/0871; E04F 13/072; E04F 13/0862; E04F 13/0864; E04F 13/0887; E04F 13/09; E04F 13/16; B29C 51/10; B29K 2101/00

(57) ABSTRACT

The present invention refers to a panel for decorative covering various substrates, e.g. interior or exterior walls and or ceilings in buildings, offices, dwellings, planes, ships, trains, etc. The covering panel provides continuous, authentic and esthetic visual appearance of the covered substrate without visible seams, separating lines, or any other borders between adjacent panels.

### RELATED APPLICATION

This application claims priority to Provision Application Ser. No. 62/031,396, filed Jul. 31, 2014, the entire contents of which is incorporated herein by reference.

### FIELD OF INVENTION

The present invention refers to a decorative cover panel for mounting on a flat or on a curved wall or on a ceiling, or on any other either flat or curvilinear surface or substrate. The cover panel of the present invention serves for decoration and it provides highly aesthetic appearance to the covered substrate including clear presentation of tiny details. The cover panel in accordance with the present invention is manufactured preferably by a vacuum forming or by a thermo-forming process. The cover panels of the invention allow achieving seamless appearance of the covered substrate.

The present invention relates to decorative panels for covering interior or exterior walls (e.g. in buildings, offices, dwellings, planes, ships, trains etc.) with highly aesthetic appearance, and in particular to decorative covering panels having thickness of not more than 1.7 mm ( 11/16″) or less. The vacuum formed or thermo-formed wall cover panels of the present invention can be manufactured from a thermoplastic material. The rear face of the panel of the present invention comprises an attachment grid while its front face comprises overlapping elements rendering the installation of the panels easy, fast and convenient while preserving the aesthetics appearance and performance of the panels during their service.

### BACKGROUND OF THE INVENTION

Many types of interior wall panels are currently known. The interior wall panels are used in the construction and improvement of residential, commercial, industrial and other buildings as well as transportation vehicles such as trains, ships planes etc. Typically, such panels are made from a lightweight composite plastic material and are manufactured by using conventional extrusion molding, injection molding, impression molding, conventional vacuum molding or thermal molding processes. There are also known panels made of painted or laminated milled MDF (Medium Density Fiberboard), or from thin metal, from cellulose and from other materials. Such panels may be formed in various shapes, such as individual elongated sections similar to standard aluminum siding or single panels provided with one or more rows of individual decorative elements or alternatively with random patterns.

Individual panels are often connected to the previously installed identical panels with the aim of a vertical attachment and a horizontal attachment where portions of the panel overlap with portions of previously installed panels. Large panels can be attached to the surface to be covered in a H or in a T arrangements (channels or profiles) or by plasters and painting to cover the parting (separation) lines.

The known in the art laminated, thin vacuum-formed and thermo-formed panels for wall covering usually are limited to imitating of a relatively flat pattern. Such panels are available on the market today. The attachment of these panels to the neighboring panel is effected by overlapping of a lip provided in one panel and an edge provided in an adjacent panel. The edge is parallel to or is slanted at a low angle with respect to the substrate plain face. Unfortunately in this arrangement the connecting lines between the adjacent panels are visible as can be seen in FIG. 11.

Prior known standard vacuum thermal process panels have also been used to provide a simulated shake (or other detailed) elements on polymer panels as mentioned in patents U.S. Pat. No. 4,598,522 A, U.S. Pat. No. 4,251,967 A;

However, the aesthetic appearance and tiny details of panels obtained with this covering process is considerably lacking (reference U.S. Pat. No. 7,698,864 B2 (background of the invention).

There are known in the prior art so called milled MDF (medium density fiberboard) panels covered with thin thermoplastic material or painted. They are expensive to manufacture, they cannot imitate such pattern like rough stones or rough wood and they leave a visible connecting lines between adjacent panels. Those lines should be eventually hided by painting with plaster.

Furthermore, injection molded panels couldn't provide high quality pattern imitating of appearance of metallic or wood materials, due to technological problems of surface covering with metallic foils, wood grain foils etc.

The known in the art metallic cover panels can't provide clear and correct appearance of fine and tiny details and such panels cover a substrate there are visible connecting lines.

Prior known cellulose panels have to be plastered in order to hide panel connection lines and then painted. Cellulose panels can't show the fine details of the cover.

In conclusion one can said that despite various cover plates are known in the art there is still felt the necessity in new cover plates, which would be inexpensive in manufacture, which would not suffer from deficiencies of the known cover plates and which would provide sufficient authentic and esthetic appearance when they are assembled to cover a substrate, and which would be suitable for assembling by overlapping between neighboring plates to provide continuous pattern with no visible gaps or seams or any other borders between the neighboring plates.

### SUMMARY OF THE INVENTION

The term surface or wall or ceiling means here either a flat or a curved substrate to be covered by decorative panels of the present invention.

The term interlocking jagged edge which will be mentioned further means an edge of the cover panel which contour is irregular and sharply uneven and which is configured in such a manner that fast and convenient positioning and assembling of the adjacent panels becomes possible while providing the covered surface with continuous and seamless appearance.

The term seamless connecting line means that no visible borders between neighboring panels could be seen, i.e. the covered surface appears continuous, with no apparent gaps or lines between one cover panel and the neighboring cover panels.

The term panel in this disclosure comprises sheet or board as well.

The term region means an area on the frontal face of a panel which is delimited by a distance of 5-50 mm from the panel edge. Within this region overlapping and interlocking of jagged edges of the adjacent panels is achieved.

The term continuous authentic look means such appearance of the covered substrate that respective ends of adjacent panels are invisible or in other words where there is no visible seems, gaps, connection lines or any other borders between adjacent panels which could destroy an impression of continuity of a pattern provided on the panels. It can be appreciated that by virtue of this feature the appearance of the covered substrate looks authentic and esthetical.

The term rotational symmetry with reference to the cover panel of the present invention means that the panel still looks the same after a rotation on one full (180 degrees) turn.

It is an object of the present invention to provide a covering pan& for mounting on either flat and/or curved walls or ceilings, which upon assembling provides a pattern having authentic, continuous, three dimensional and seamless look (to be used in buildings, offices, dwellings, planes, ships, trains etc.)

It is a further object of the invention to provide a new and inexpensive cover panel, which can be easily manufactured by vacuum forming process or by thermo-forming process.

Still further object of the present invention is to provide a new cover panel which enables to use thin sheets and thus to make the manufacturing of the panel efficient and economical.

Another object of the present invention is to provide a new cover panel, which can be manufactured by using of up to 40% of recycled wall covering panels.

Yet another object of the invention is to provide a new cover panel, which upon covering would provide a pattern having aesthetic accurate look imitating or detailed metallic, wood grain, stone or other common patterns of a façade.

Another object of the present invention is to provide a new cover panel, which can be easy positioned on the surface to be covered and easily assembled/disassembled with the adjacent panels.

Another object of the present invention is to provide a new cover panel configured and dimensioned in such a manner that there is provided a possibility for assembling the plates on the surface to be covered by overlapping of straight edge of one panel with interlocking jagged edge of the adjacent panel while still keeping continuous, seamless and authentic look of the covered surface. By virtue of this provision it is possible to use each panel as a middle panel or as a side panel and eliminate the need in cutting panels during assembling.

Still further object of the present invention is to provide a new, efficient and economical method for manufacturing of cover plates, which is associated with low expenditure of materials and with reduced production costs.

Still further object of the present invention is to provide a new method for manufacturing cover plates which is associated with providing on the rear (back) face of a panel a grid, wherein said grid consists of plurality of cells delimited by thin walls, which reinforce the plate.

The other object of the present invention is to provide a new method for manufacturing cover panels in which the walls of the cells have the same height such that their ends define a base plane for positioning of the panels on the surface to be covered.

Still further object of the present invention is to provide a new method for manufacturing cover panels, in which said grid is configured and dimensioned in such a manner that interior of the cells delimited by their thin walls is sufficient to provide a room for excessing adhesive material during positioning the panels on the surface to be covered.

Another object of the present invention is to provide a method for manufacturing cover plates, which is based on at least one of the methods selected from conventional extrusion molding, injection molding, impression molding, conventional vacuum molding and thermal molding.

### LIST OF DRAWINGS REFERRING TO SOME EMBODIMENTS OF THE INVENTION

Corresponding reference numerals presented on the figures indicate corresponding elements throughout the several views. Although the drawings represent embodiments of the present invention, the drawings are not necessarily to scale and certain features may be exaggerated in order to better illustrate and explain the present invention.

Other objects and advantages of the invention will become apparent upon reading the following detailed description and upon reference to the drawings, in which:

FIG. 1A, 1B, 1C are respective views of a surface covered by cover panels in accordance with the present invention.

FIG. 2 is an isometric top view of a cover panel in accordance with the present invention showing front face thereof.

FIG. 3 is another isometric top view of the panel depicted in FIG. 2.

FIG. 4 is an isometric view of a rear face of the cover panel depicted in FIG. 2 and FIG. 3.

FIG. 5 is an isometric view of two cover panels oppositely positioned before they are assembled.

FIG. 6 is another isometric view of two cover panels positioned before they are assembled.

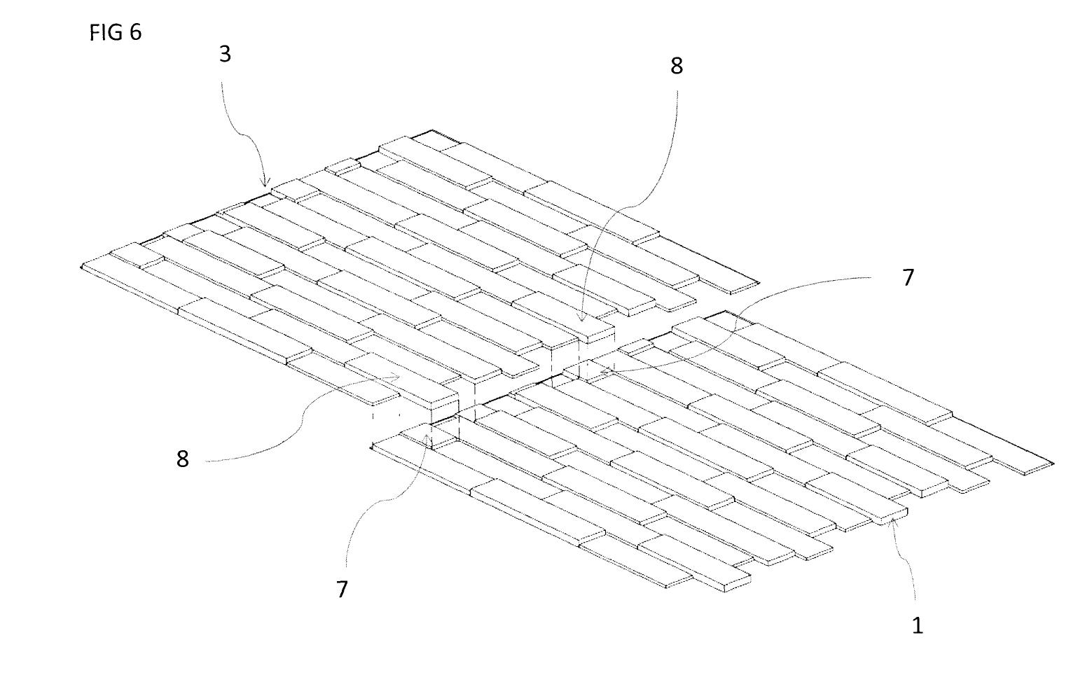

FIG. 7 is a side view of the cover panel of the present invention along with enlarged fragment that shows reduced patterns at the edge of the panel, and positioning grid.

FIG. 8 is another side view of the cover panel of the present invention along with enlarged fragment.

FIG. 9 is a side view of two assembled cover panels and a cross-section.

FIG. 10 is an isometric view of two cover panels positioned before they are assembled.

FIG. 11 is a top view of prior art cover panel with a cross-section A-B.

FIG. 12 is an isometric view of a cover panel constructed in accordance with the present invention and provided with a pattern which is different from the pattern shown in the FIGS. 1-11.

### DETAILED DESCRIPTION OF THE INVENTION

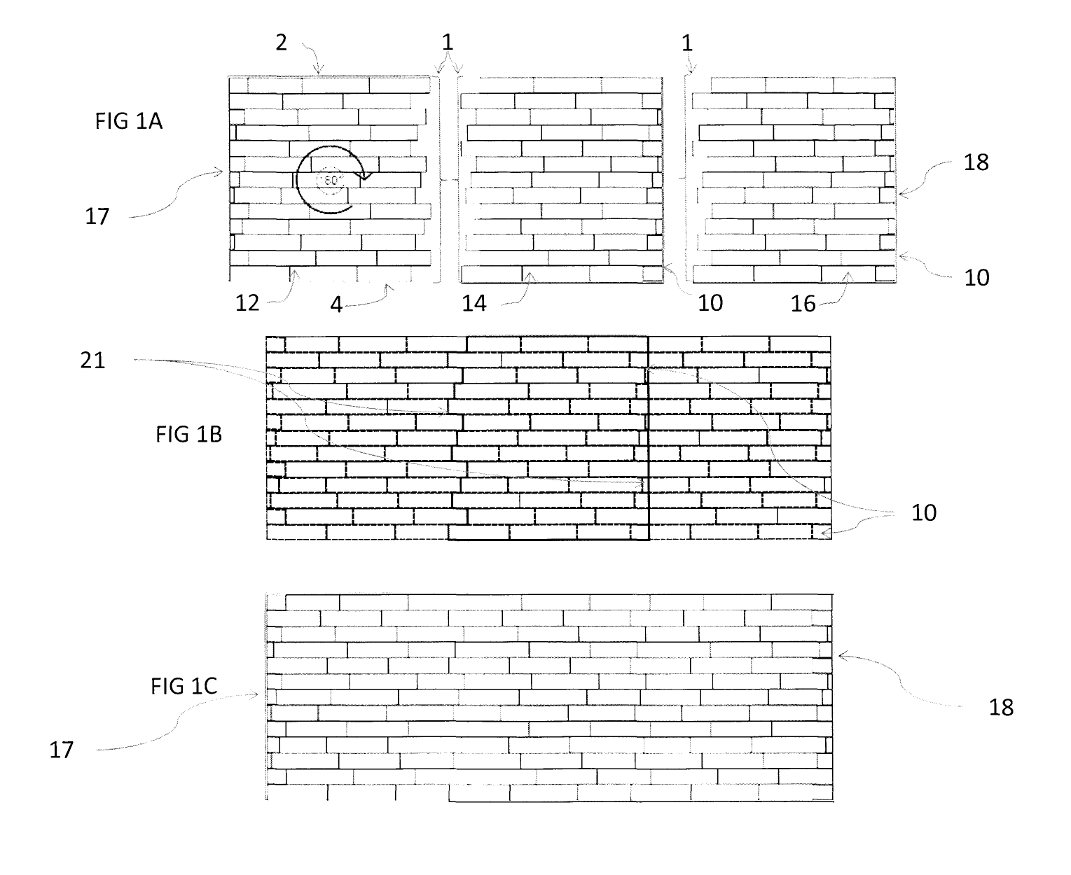

Referring now to FIGS. 1A, 1B and 1C of the drawings, there are shown illustrative views of different situations when a substrate, e.g. wall or a ceiling is being covered by cover

In FIG. 1A are shown three cover panels which are configured as rectangles 12, 14, 16. The panels are delimited by horizontal straight peripheral edges 2, 4, by vertical straight lowered peripheral edge 17 (for panel 12) and 10 for panels (14, 16) and by vertical interlocking jagged edge 1 (for panel 16, 14,12).

The panels are shaped as modules, having similar configuration. The panels are shown when they are ready for assembling on a substrate (not shown). The panels are positioned in such a manner that interlocking jagged edge 1 of panel 12 is situated opposite to interlocking jagged edge 1′ of panel 14 and straight edge 10 of panel 14 is opposite to interlocking jagged edge 1″ of panel 16.

A decorative pattern is provided on a front face of the cover panels seen in FIGS. 1A, 1B and 1C. In the present case the cover panels are formed with a pattern, which simulates wooden shingles having varying depth while constant width and length. The shingles are arranged in rows along the length dimension of the cover panels.

The simulated shingles or any other decorative pattern can be printed or filmed or painted to imitate wood grain, stone, fabric leather or other pattern.

It will be understood that the panels could be provided with other configuration and with other decorative patterns imitating stones, grooved wood, bricks, metals or other types of decorative materials, such as fabrics, curved wood and the like. The decorative pattern could be arranged on the front face of the panel either irregularly or in a regular order.

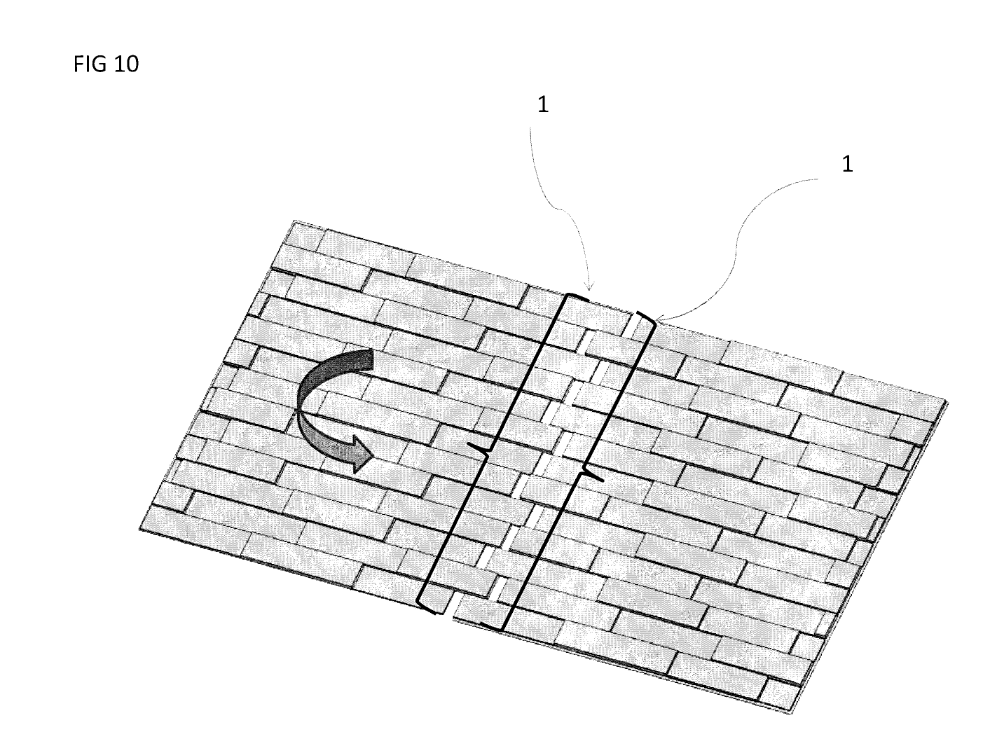

In FIG. 1B and 10 is shown a fragment of a substrate covered by cover panels of the invention.

One of the benefits of the present invention as can be seen in FIGS. 1A, 1B and 1C is the achieving of continuous and seamless appearance of the covered surface after the panels are mounted thereon, where one can see panel contours only as shown by numeral 21 in FIG. 1B, which is an invisible hidden line on the covered surface.

No visible border between neighboring panels can be seen, no apparent gaps or partition line between one panel and the neighboring panels. This seamlessly covered surface can be achieved with the panels of the present invention by virtue of an interlocking jagged region arranged on their opposite straight edges. This region will be explained in more details further.

In accordance with the invention the interlocking jagged regions are provided at opposite straight edges of the panel and those jagged regions are configured such that rotational symmetry exists between them. In FIG. 1A and 1C one can see right and left straight edges of the panels, which are designated by numerals 17 and 18. By virtue of rotational symmetry of the jagged edges of neighboring panels it becomes possible to cover the surface by modular panels of the present invention without cutting them.

The possibility to create a seamless appearance of the covered surface with no need for cutting of the panels is achieved by virtue of rotational symmetry of interlocking jagged regions arranged on the panels. Such region can be seen in FIG. 1A and it is designated by reference numeral 1. The rotational symmetry allows 180 degree rotation of a panel such that during the assembling the adjacent panels are arranged with full adaptation and interlock engagement of their respective jagged regions. As a result of this arrangement an inter-engagement is possible between overlying upper marginal edge regions associated with one panel and jagged edge of the adjacent panel. This arrangement renders the appearance of the decorative pattern seamless.

In particular the seamless appearance of the covered substrate is achieved by virtue of the following:

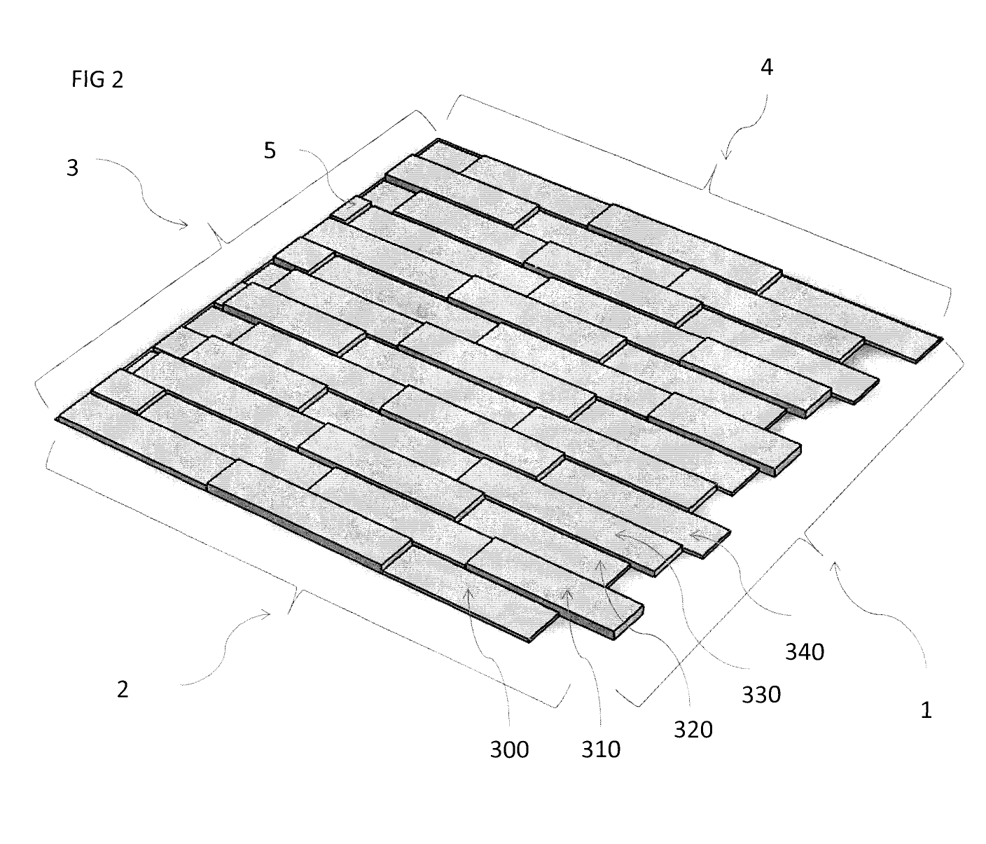

As seen in FIG. 2, 3 the modular rectangular panel is provided with at least one vertical interlocking jagged edge region 1 delimited by a contour that continues the pattern seen on the front face of the panel. This pattern consists of vertically protruding from the frontal face rectangular elements interspersing with vertically depressed rectangular elements. The rectangular elements imitate shingles.

Furthermore the rectangular elements arranged in the jagged region of the jagged edge 1 protrude horizontally. This protrusion is uneven and irregular. One can see for example in FIG. 2 rectangular elements 300,320,340 which are depressed with respect to the frontal face of the panel. Those rectangular elements intersperse with rectangular elements 310, 330, which protrude from the frontal face of the panel.

At the same time the rectangular elements 300,310,330,340 unevenly and irregularly protrude in horizontal direction.

The adjacent horizontal edge 3 of the panel is formed with a lip as can be seen in FIG. 2.

The second horizontal edge 4 of the panel is also provided with a lip (with relation to the substrate surface).

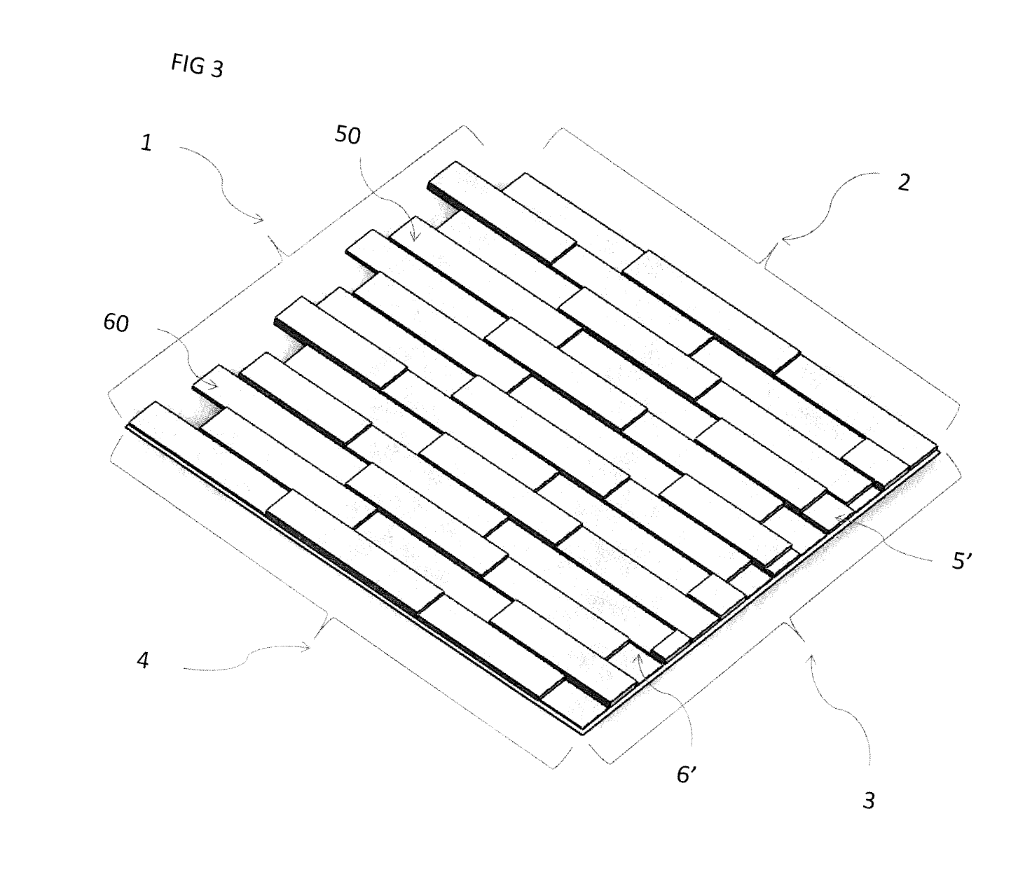

The second horizontal edge 3 of the panel is straight and adjacent thereto there is provided similar interlocking jagged region comprising depressed (reduced) rectangular elements interspersing with protruding rectangular elements. For example, it is seen in FIG. 3 protruding rectangular elements 5, 6.

In accordance with the invention the interspersing of rectangular elements associated with the interlocking jagged edge 1 of the panel and with the opposite straight edge 3 is deliberately arranged in such a manner that upon rotation by 180 degrees of a first panel and assembling thereof with an adjacent second panel the protruding rectangular elements associated with the jagged edge of the second panel could overlap with depressed rectangular elements of the jagged region associated with the first panel and vice versa. For example, in FIG. 3 are shown depressed rectangular elements 50, 60, which are located within the jagged edge region 3 of a panel so as to overlap with the corresponding rectangular elements 5′,6′ associated with the jagged edge region of the second panel.

By virtue of this provision it is possible to achieve overlapping and interlocking between the jagged edge of one panel with the jagged edge of an adjacent panel.

Horizontal edge of the cover panel is provided with corresponding horizontal lip as seen in FIG. 3, numeral 4.

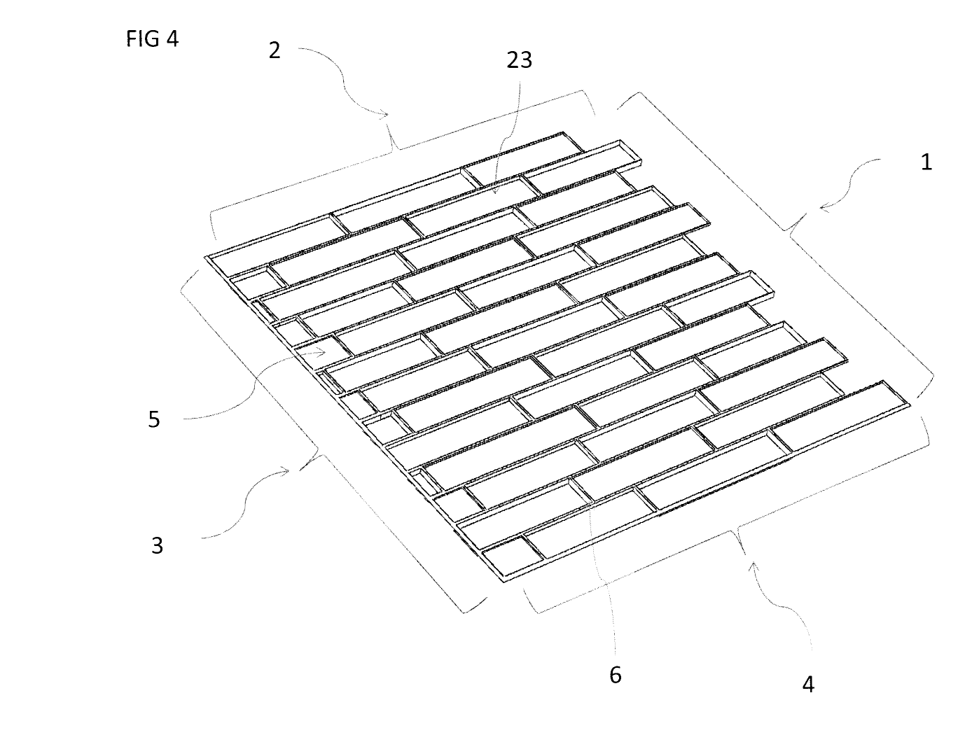

Rear or back face of the cover panel in accordance with the present invention is shown in FIG. 4. It comprises a grid 6 consisting of a plurality of rectangular cells or cavities 23 delimited by thin walls. It can be readily appreciated that thin walls delimiting the cavities provide strength to the panel. It is not designated specifically however should be appreciated that shape of the cavities matches to the shape of rectangular elements provided on the front face of the plate.

The walls defining the cells are of the same height, which in practice is not more than 10 mm and the thickness of the walls is not more than 1.7 mm.

By virtue of this provision the rear face provides a base reference plane such that the panel can be attached to the being covered substrate and secured thereon by any suitable method, e.g. by gluing by a suitable adhesive. By virtue of this provision the panel could be attached easily and accurately to the substrate. The interior of the cavities which is delimited by the thin walls provides room for dispensing excessing adhesive.

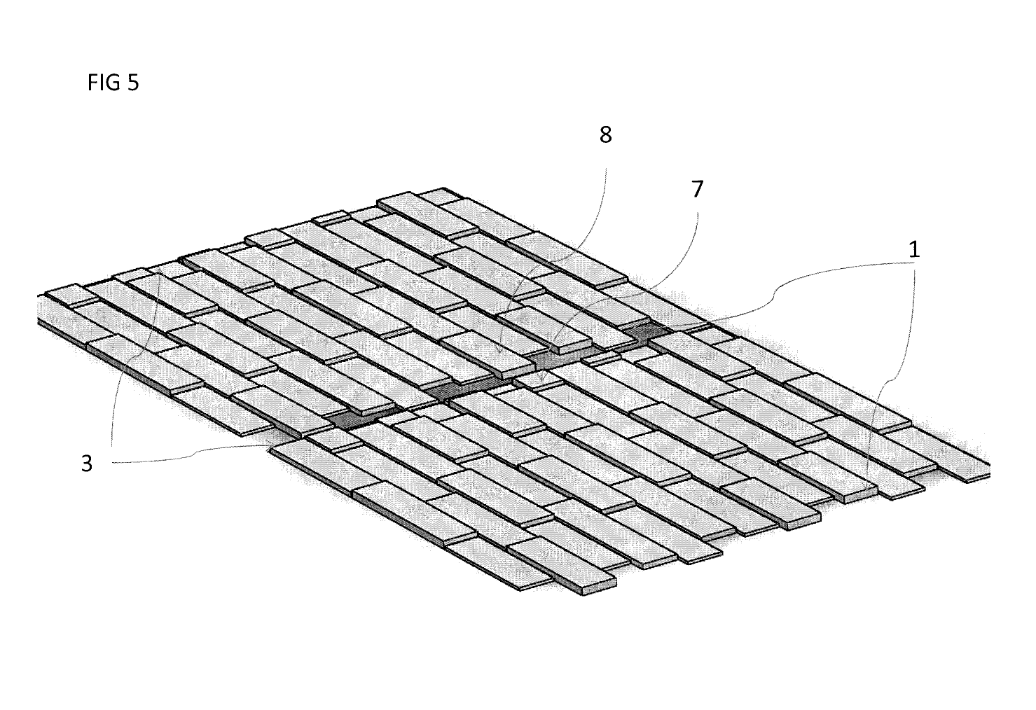

The reduced/lowered jagged region seen in FIG. 2,3,4,5 is configured and dimensioned to accommodate and receive on top of it the corresponding jagged interlocking region of the neighboring panel as can be seen in FIG. 2,3,4,5. And in particular, protruding element which is designated by numeral 7 in FIG. 5, 6 can accommodate on it s depressed element designated by numeral 8 in FIG. 5, 6. This arrangement provides seamless continuous appearance to the covered surface and allows putting the neighboring panel in the right position.

Depressed/Reduced elements on the interlocking jagged region 3 are designed with the same pattern as the corresponding elements in the interlocking jagged region 1 but smaller. This is one of the new things this invention brings to the world. This enables to use the panel with interlocking cover of neighboring panel when positioned in the middle of a wall and without cover at the edge of a complete wall as can be seen in FIG. 1C.

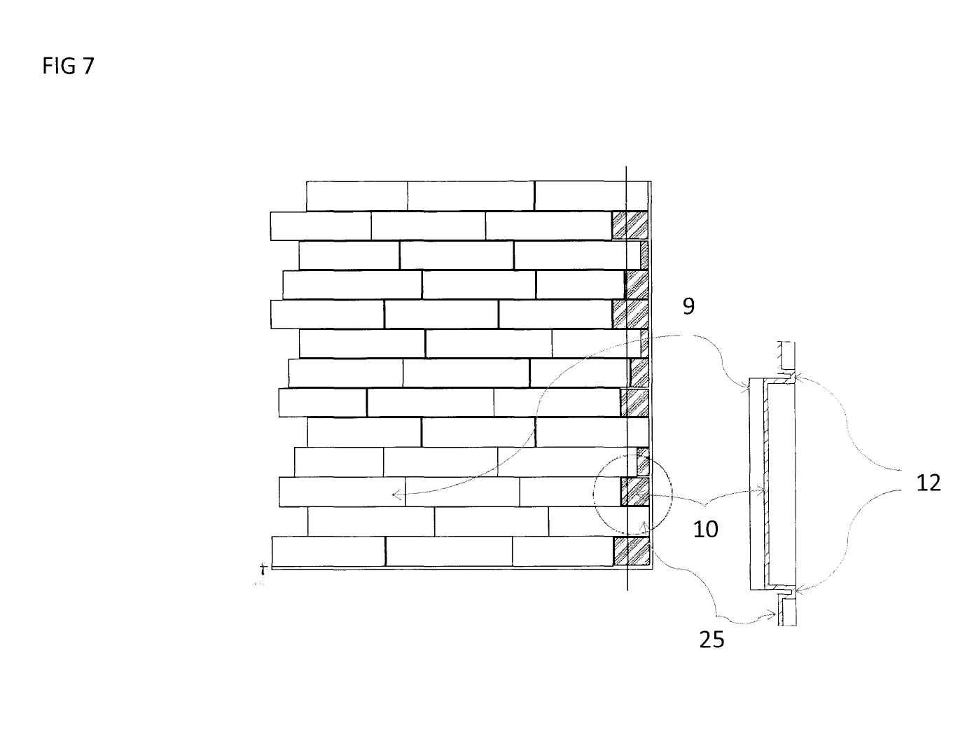

In FIG. 7 we can see top view and section side view of the lower interlocking jagged region. One can see line 10 which represents the top surface of one representative form at the lower interlocking region; it is designated by lineal thick line. The thin line designated by numeral 9 shows the top form at the interlocking jagged region (the other side of the panel). One can see the difference in height between these elements that enables the neighbor panels to interlock.

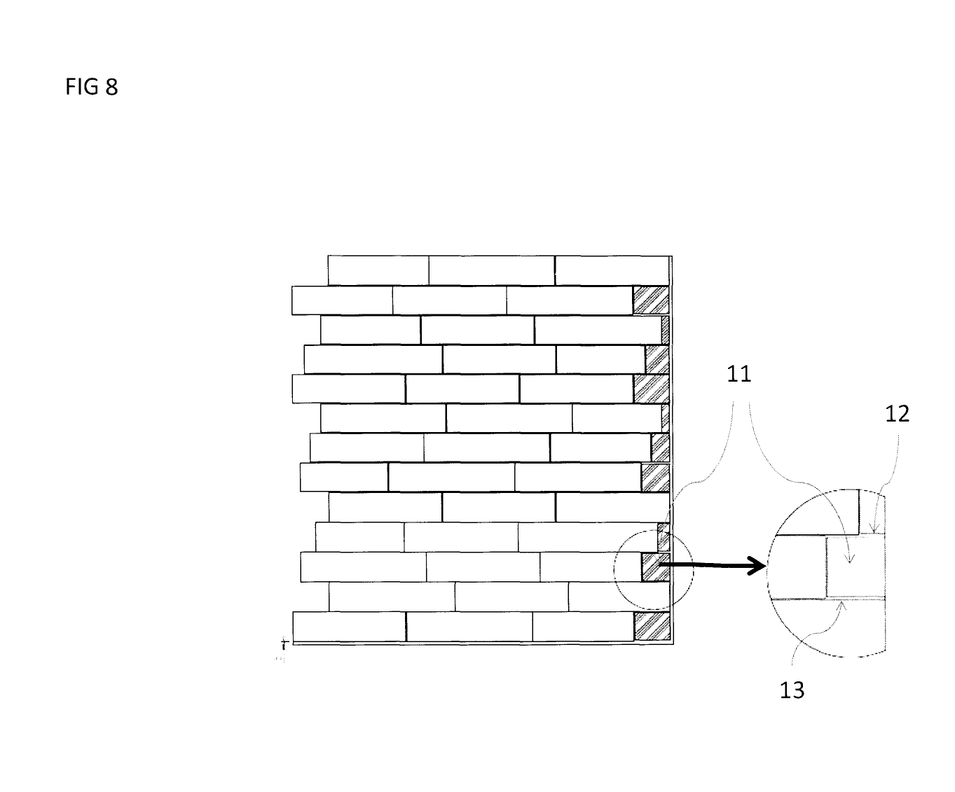

In FIG. 8 a top view of the depressed elements is presented. They are provided in the interlocking jagged region 3. One can appreciate that the grid is a little bit thicker in the lower interlocking region as designated by reference numeral 12, this gives enough space to the top interlocking jagged edge having vertical lip but is almost unnoticeable and hence keeps the authentic and continuous look of the panel when we use it uncovered at the edges of a wall or a surface.

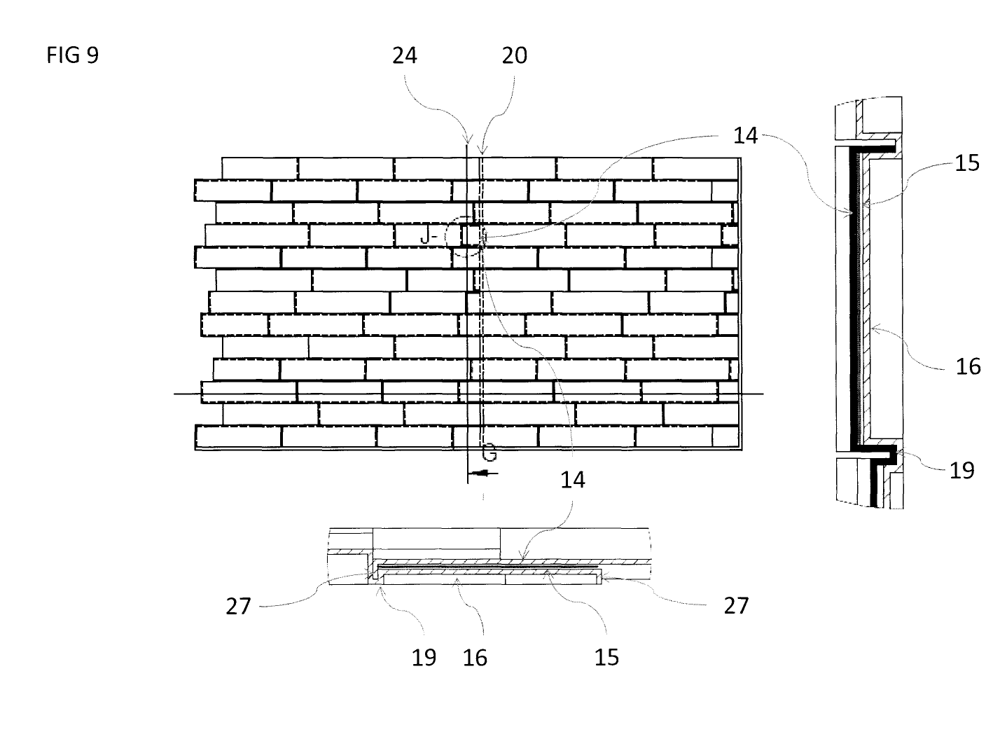

FIG. 9 shows interlocking of neighboring panels as mentioned above and 2 cross-sections that show side view of the interlocking area. The line designated as 24 is the cross-section and line 20 is a hidden line which represents the edge of the lower panel. By numeral 14 is designated the top panel in the interlocking jagged region, by numeral 15 is designated the adhesive and by numeral 16 is designated the lower interlocking region in the lower panel, by numeral 19 is designated the wall of the grid provided on the rear face of the panel. The numeral 27 designates the top panel interlocking jagged edge secured in its position by the grid provided on the rear face of the panel.

FIG. 10 shows rotational symmetry of a cover plate provided with the jagged edge region in accordance with the present invention. We can see adjacent left and right cover pan& in a position in which their respective jagged edge regions 1,1′ are brought in a vis-à-vis position ready to interlock. To achieve this position left panel should have been rotated by 180 degrees as shown by an arrow and then transposed right such that its jagged edge region would be ready to interlock with the corresponding jagged edge region of the left panel. One can easily appreciate that this rotational symmetry feature allows rotating the panel while keeping its ability for interlocking, this helps to cover walls without the need to cut the panel and is one of the major advantages of this invention.

In order to help understanding the new points of our invention we added a drawing of current panels.

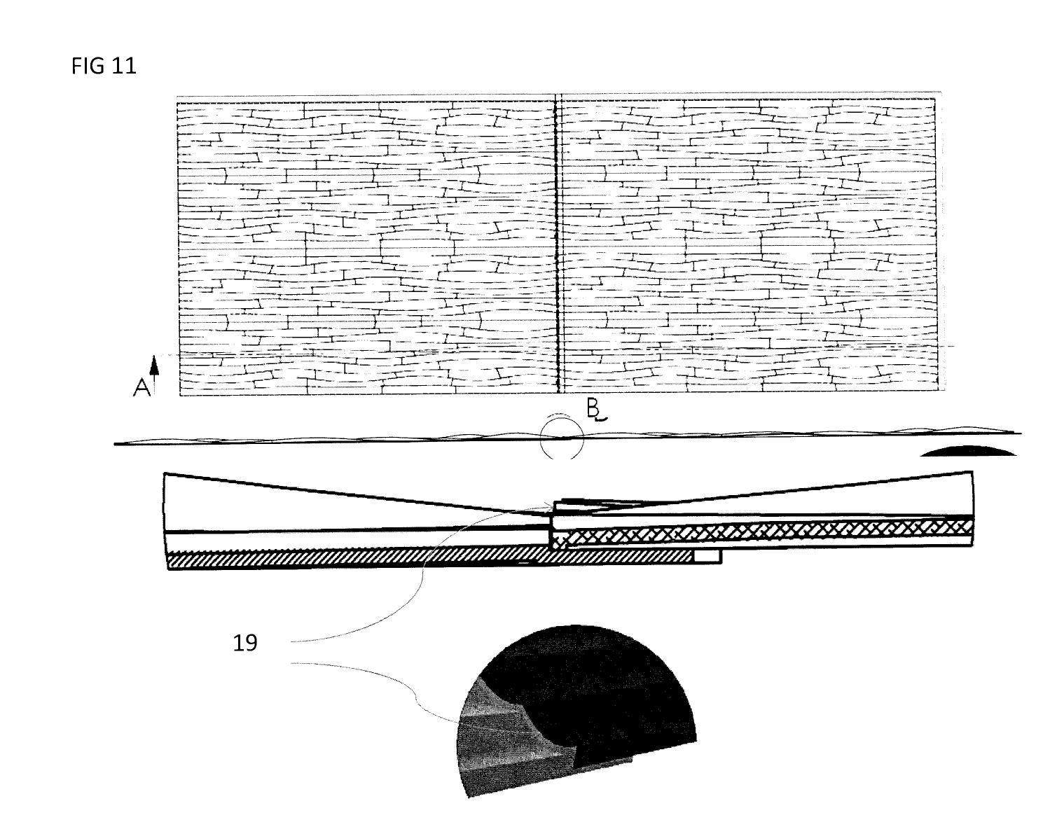

One can see that the prior art arrangement between neighboring cover panels at the edges is horizontal edge (with relation to substrate plane) and hence the connecting line can be seen easily, see also enlargement of connecting area between panels designated by reference numeral 19 in FIG. 11.

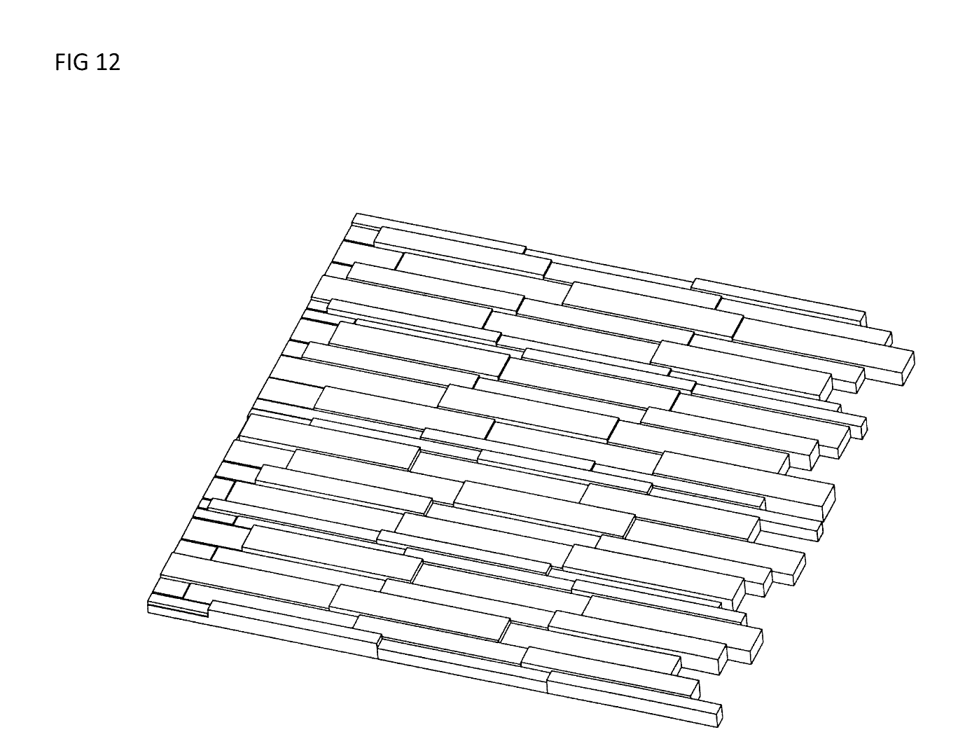

In FIG. 12 you can see another design of a panel constructed in accordance with the present invention. This panel is provided decorative pattern, which differs from the pattern shown in previous figures. Still further decorative patterns can be used with the panel of the present invention. Some possible decorative patterns include stones, wood grain with deep lines and other patterns.

1. A panel for covering a substrate, said panel having a front face and a rear face, while at least a portion of the front face is provided with a decorative pattern, said panel being delimited by peripheral edges, while at least one of the peripheral edges comprises a region, which is configured and dimensioned as an interlocking jagged region such that during the covering of the substrate the respective interlocking jagged regions of adjacent panels can interlock and overlap one with another such that there is provided a continuous, authentic and esthetic appearance of the covered substrate without visible seams, separate lines, or other borders between the adjacent panels.

2. The panel as defined in claim 1, in which the interlocking jagged region comprises depressed and protruding elements.

3. The panel as defined in claim 1, in which the panel is configured as a rectangle.

4. The panel as defined in claim 3, in which the decorative pattern imitates shingles.

5. The panel as defined in claim 4, in which the interlocking jagged region comprises depressed and protruding elements which are configured as interspersing rectangles.

6. The panel as defined in claim 5, wherein said depressed and protruding elements are arranged in such a manner that there exists rotational symmetry between interlocking jagged region associated with one peripheral edge of the panel and interlocking jagged region associated with an opposite peripheral edge.

7. The panel as defined in claim 6, in which upon rotation of the panel by 180 degrees and assembling thereof with an adjacent panel the protruding rectangular elements associated with the interlocking jagged edge of the adjacent panel could overlap with the depressed rectangular elements of the interlocking jagged region associated with the first panel and vice versa.

8. The panel as defined in claim 1, in which the panel is manufactured from a polymeric material.

9. The panel as defined in claim 8, in which the panel is manufactured by a method selected from conventional extrusion molding, injection molding, impression molding, conventional vacuum molding and thermal molding.

10. The panel as defined in claim 9, in which a rear face of the panel comprises a grid, consisting of a plurality of cavities, said cavities are delimited by walls, such that configuration of the cavities corresponds to configuration of the decorative pattern provided on frontal face of the panel.

11. The panel as defined in claim 10, in which the cavities are delimited by walls having the same height, such that the panel can be attached to the substrate.

12. The panels as defined in claim 10, in which upon attachment the panel is secured on the substrate by an adhesive.

13. The panel as defined in claim 12, in which said cavities provide a room for an excess of the adhesive.

14. The panel as defined in claim 9, in which said panel is configured as a sheath of polymeric material having thickness not more than 1.7 mm.

15. The panel as defined in claim 10, in which the grid is configured in such a manner that on the front face of the panel are provided grooves that separate elements of the decorative pattern, wherein said grooves upon assembling of the panels lock and hide lips provided on straight edges of the panels.

16. The panel as defined in claim 10, in which the pan& is delimited by two straight vertical edges provided with respective lips and with two horizontal edges provided with respective lips.

17. The panel as defined in claim 1, in which the decorative pattern on the front face of the panel is manufactured by a method selected from printing, hot stamping, digital printing and screen printing.
